(19) United States
(12) Patent Application Publication
(10) Pub. No.: US 2026/0143233 A1
(43) Pub. Date: May 21, 2026

(54) IMAGING SYSTEM MODULE AND IMAGING APPARATUS

(71) Applicant: Japan Display Inc., Tokyo (JP)

(72) Inventors: Hirondo NAKATOGAWA, Tokyo (JP); Yoshiro AOKI, Tokyo (JP); Hitoshi TANAKA, Tokyo (JP)

(21) Appl. No.: 19/386,396

(22) Filed: Nov. 12, 2025

(30) Foreign Application Priority Data
Nov. 18, 2024 (JP) 2024-200957

(51) Int. Cl. H04N 23/68; G02B 7/02; G03B 9/02; H04N 23/55; H04N 23/95

(52) U.S. Cl. CPC H04N 23/683; G02B 7/021; G03B 9/02; H04N 23/55; H04N 23/95

(57) ABSTRACT

An imaging system module includes a first lens, a second lens disposed on an optical axis of the first lens, a liquid crystal panel disposed between the first lens and the second lens, and a cylindrical member having a cylindrical shape and supporting the first lens, the second lens, and the liquid crystal panel inside a cylinder. The liquid crystal panel is controlled externally to form an aperture having a designated pattern such as a coded aperture. A panel surface of the liquid crystal panel has an N-polygonal shape or a circular shape. Here, N is a natural number greater than four.

### CROSS REFERENCES TO RELATED APPLICATIONS

The present application claims priority to Japanese Patent Application No. 2024-200957 filed on Nov. 18, 2024, the disclosure of which is incorporated herein by reference.

### BACKGROUND

The present disclosure relates to an imaging system module and an imaging apparatus.

In the field of coded imaging, a technique referred to as Depth From Defocus (DFD) is known. The DFD technique is a technique for estimating the distance from an optical system of an imaging apparatus to a subject, that is, the distance or depth of the subject, based on the degree of blur of an edge appearing in an image obtained by imaging.

The DFD technique is described, for example, in “Coded Aperture Pairs for Depth from Defocus and Defocus Deblurring” C. Zhou, S. Lin and S. K. Nayar, International Journal of Computer Vision, Vol. 93, No. 1, pp. 53, May 2011 (Non-Patent Document 1). In the DFD technique, coded imaging is performed in which a mask referred to as a coded aperture is disposed in a light incident region of an optical system to image a subject. Then, a decoding process based on a point spread function specific to the mask is performed on the image obtained by the coded imaging, whereby the depth of the subject is estimated. The point spread function is generally referred to as a PSF, and is also referred to as a blur function, a blur spread function, or a point spread function.

### SUMMARY

The DFD technique is still in the stage of development, and there remains much room for improvement in terms of practicality. Likewise, in an imaging apparatus used for coded imaging or in an imaging system module constituting the imaging apparatus, there remains room for improvement in practicality.

An object of the present disclosure is to provide an imaging system module and an imaging apparatus having improved practicality.

Among the disclosures disclosed in the present application, representative ones will be outlined as follows.

According to one representative embodiment, an imaging system module includes a first lens, a second lens disposed on an optical axis of the first lens, a liquid crystal panel disposed between the first lens and the second lens, and a cylindrical member having a cylindrical shape and supporting the first lens, the second lens, and the liquid crystal panel inside a cylinder, in which the liquid crystal panel is controlled externally to form an aperture having a designated pattern, in which a panel surface of the liquid crystal panel has an N-polygonal shape, and in which N is a natural number greater than four.

According to one representative embodiment, an imaging system module includes a first lens, a second lens disposed on an optical axis of the first lens, a liquid crystal panel disposed between the first lens and the second lens, and a cylindrical member having a cylindrical shape and supporting the first lens, the second lens, and the liquid crystal panel inside a cylinder, in which the liquid crystal panel is controlled externally to form an aperture having a designated pattern, and in which a panel surface of the liquid crystal panel has a circular shape.

According to one representative embodiment, an imaging apparatus includes an imaging system module, and an arithmetic control unit, in which the imaging system module includes: a first lens, a second lens disposed on an optical axis of the first lens, a liquid crystal panel disposed between the first lens and the second lens, and a cylindrical member having a cylindrical shape and supporting the first lens, the second lens, and the liquid crystal panel inside a cylinder, in which the liquid crystal panel is controlled by the arithmetic control unit to form an aperture having a designated pattern, in which a panel surface of the liquid crystal panel has an N-polygonal shape, in which N is a natural number greater than four, and in which the arithmetic control unit controls the imaging system module so that coded imaging is performed, and decodes an imaged image obtained by the coded imaging to calculate an estimated depth value of a subject.

According to one representative embodiment, an imaging apparatus includes an imaging system module, and an arithmetic control unit, in which the imaging system module includes: a first lens, a second lens disposed on an optical axis of the first lens, a liquid crystal panel disposed between the first lens and the second lens, and a cylindrical member having a cylindrical shape and supporting the first lens, the second lens, and the liquid crystal panel inside a cylinder, in which the liquid crystal panel is controlled by the arithmetic control unit to form an aperture having a designated pattern, in which a panel surface of the liquid crystal panel has a circular shape, and in which the arithmetic control unit controls the imaging system module so that coded imaging is performed, and decodes an imaged image obtained by the coded imaging to calculate an estimated depth value of a subject.

### BRIEF DESCRIPTION OF THE DRAWINGS

FIG. 1A is a front diagram illustrating a configuration example of a reference imaging system module.

FIG. 1B is a side diagram illustrating a configuration example of a reference imaging system module.

FIG. 2 is a diagram illustrating a configuration example of a liquid crystal panel in the reference imaging system module.

FIG. 3 is a diagram illustrating the configuration example of the liquid crystal panel in the reference imaging system module.

FIG. 4 is a diagram illustrating a configuration example of an interior of a cylindrical member in the reference imaging system module.

FIG. 5 is a diagram illustrating a configuration example of a main part of the liquid crystal panel in the reference imaging system module.

FIG. 6A is a front diagram illustrating a configuration of an imaging system module according to a first embodiment.

FIG. 6B is a side diagram illustrating a configuration of an imaging system module according to a first embodiment.

FIG. 7 is a diagram illustrating a configuration example of an interior of a cylindrical member in the imaging system module according to the first embodiment.

FIG. 8 is a diagram illustrating a configuration example of a liquid crystal panel in the imaging system module according to the first embodiment.

FIG. 9 is a front diagram illustrating a configuration of a liquid crystal panel in the reference imaging system module.

FIG. 10 is a front diagram illustrating a configuration of a liquid crystal panel in the imaging system module according to the first embodiment.

FIG. 11 is a diagram illustrating a configuration example of an imaging apparatus according to a second embodiment.

FIG. 12 is a diagram illustrating a configuration example of an arithmetic control unit according to the second embodiment.

FIG. 13 is a diagram illustrating an application example of the imaging apparatus according to the second embodiment.

### DETAILED DESCRIPTION

### <Background of Examination by Present Inventors>

Before describing embodiments of the present disclosure, basic aspects of the DFD technique and issues found by the present inventors will be described.

A manner of blur of a subject in an imaged image generally depends on a point spread function determined by an optical system of an imaging apparatus and a shape of a light incident region of the optical system. When a mask that forms a coded aperture for partially shielding light is provided in the light incident region of the optical system, the point spread function depends on a geometrical pattern of the mask. Imaging a subject with an imaging apparatus in which such a mask is provided is referred to as coded imaging. When the subject is imaged by coded imaging, a blurred image based on a point spread function specific to the mask used is obtained as an imaged image.

When a decoding process is performed on the blurred image, which is the imaged image, by deconvolution based on a point spread function specific to the mask used, a decoded image with improved blur and depth information of an object corresponding to each position of a subject included in the decoded image are obtained.

Meanwhile, have conducted the present inventors examination on an imaging apparatus used for coded imaging of a subject. The present inventors have found that, in a case where a liquid crystal panel is used as a mask in an imaging system module constituting the imaging apparatus, and a configuration is adopted in which a lens and the liquid crystal panel are supported by a cylindrical member inside the cylinder, there are problems as described below.

The inventors have confirmed that, when a general liquid crystal panel is used as a mask for forming a coded aperture, it is difficult to achieve space saving because an area of an electrode portion of the liquid crystal panel, which forms the coded aperture, cannot be made sufficiently large relative to a cross-sectional area of a cylindrical member. This point will be described in detail below.

### Configuration Example of Reference Imaging System Module

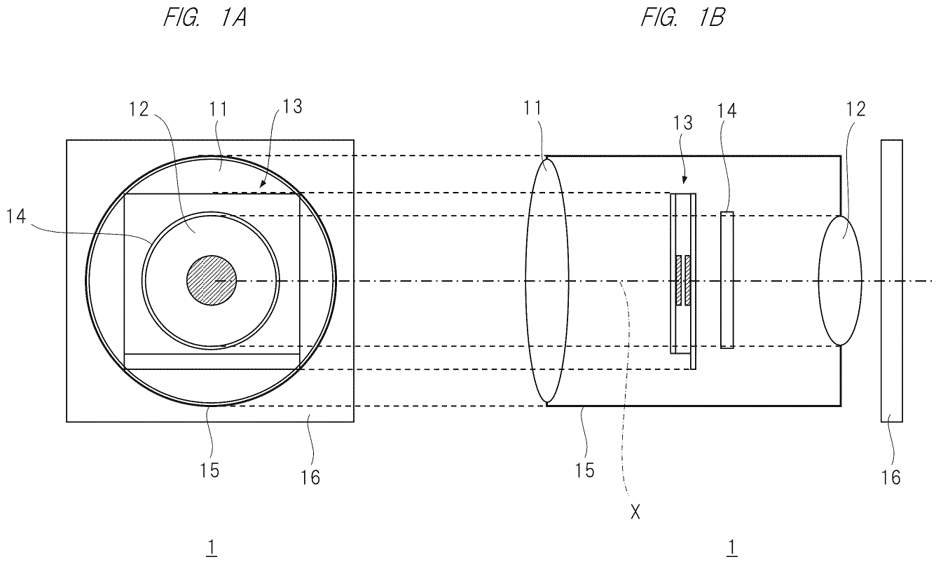

FIGS. 1A and 1B are diagrams illustrating a configuration example of a reference imaging system module. The configuration example of a reference imaging system module 1 illustrated in FIGS. 1A and 1B is a configuration example considered to be general in a case where a liquid crystal panel is applied to form a coded aperture in the imaging system module 1. FIG. 1A is a front diagram illustrating a configuration of the reference imaging system module, schematically illustrating a configuration example when the module is viewed in an optical axis direction. FIG. 1B is a side diagram illustrating a configuration of the reference imaging module, system schematically illustrating a configuration example when the module is viewed in a direction orthogonal to the optical axis. As illustrated in FIGS. 1A and 1B, the imaging system module 1 includes a first lens 11, a second lens 12, a liquid crystal panel 13, an aperture assembly 14, a cylindrical member 15, and an imaging element 16.

The first lens 11 is disposed on a subject side and collects light emitted or reflected from a subject. The second lens 12 is disposed on an optical axis x of the first lens 11 on a side opposite the subject side. The liquid crystal panel 13 is disposed between the first lens 11 and the second lens 12. The liquid crystal panel 13 is controlled externally to form an aperture having a designated pattern. When coded imaging is performed, the liquid crystal panel 13 forms a coded aperture.

The aperture assembly 14 is controlled externally to change an aperture value, that is, a size of an aperture, so that imaging is performed at a set exposure level. The cylindrical member 15 has a cylindrical shape and supports the first lens 11, the second lens 12, the liquid crystal panel 13, and the aperture assembly 14 inside the cylinder. The cylindrical member 15 is also referred to as a barrel. The imaging element 16 is disposed on the optical axis x of the first lens 11 and the second lens 12, receives light passing through the first lens 11 and the second lens 12 on a light-receiving surface, performs photoelectric conversion, and outputs image data. The imaging element 16 is also referred to as an image sensor.

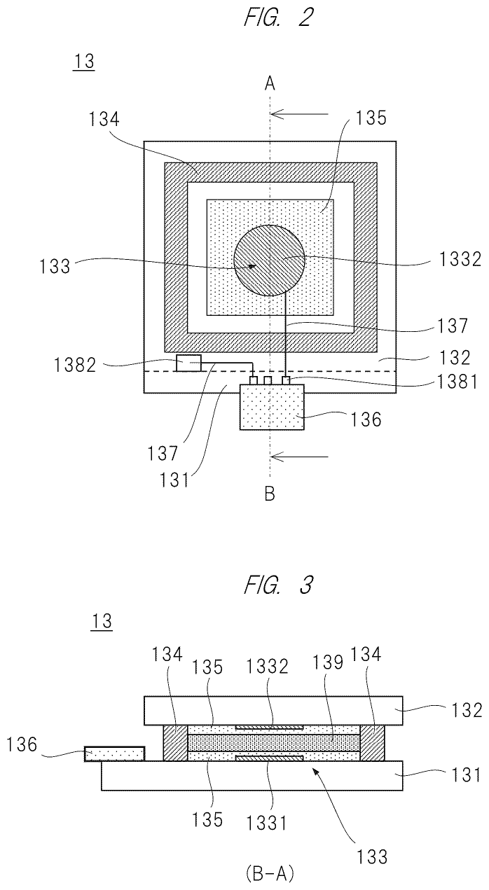

FIGS. 2 and 3 are diagrams illustrating a configuration example of a liquid crystal panel in the reference imaging system module. FIG. 2 is a front diagram illustrating a configuration of the liquid crystal panel 13, schematically illustrating a configuration example when the panel is viewed in the optical axis direction. FIG. 3 is a side diagram illustrating a configuration of the liquid crystal panel 13 and illustrates a cross section A-B of the liquid crystal panel 13 in FIG. 2. As illustrated in FIGS. 2 and 3, the liquid crystal panel 13 includes an array substrate 131, a counter substrate 132, an electrode portion 133, a sealing material 134, alignment films 135, and liquid crystal 139.

The array substrate 131 is a glass substrate provided with an electric circuit function for driving the liquid crystal 139. The counter substrate 132 is a glass substrate disposed to face the array substrate 131. The sealing material 134 is disposed in close contact between the array substrate 131 and the counter substrate 132 and has a frame-like shape surrounding a predetermined region. The electrode portion 133 includes a first electrode portion 1331 and a second electrode portion 1332 respectively disposed on mutually facing surfaces of the array substrate 131 and the counter substrate 132. The first electrode portion 1331 is disposed on a surface located inside the sealing material 134 on the array substrate 131 side. The second electrode portion 1332 is disposed on a surface located inside the sealing material 134 on the counter substrate 132 side. The first electrode portion 1331 and the second electrode portion 1332 are so-called transparent electrodes that transmit light.

The first electrode portion 1331 disposed on the array substrate 131 side is, for example, configured as a single electrode extending over a region corresponding to the second electrode portion 1332 or a region larger than that. On the other hand, the second electrode portion 1332 disposed on the counter substrate 132 side is, for example, configured such that a circular electrode is divided into a plurality of partial electrodes. It should be noted that a positional relationship between the first electrode portion 1331 and the second electrode portion 1332 may be reversed.

The array substrate 131 and the counter substrate 132 generally have rectangular plate surfaces. This is because a method of manufacturing a plurality of substrates by cutting a large transparent substrate in a grid pattern is efficient and extremely common. In other words, substrates having plate surfaces of non-rectangular shapes are uncommon because cutting such substrates requires extra processing. In the liquid crystal panel 13 of the reference imaging system module 1, the array substrate 131 has a square plate surface, and the counter substrate 132 has a rectangular plate surface slightly shorter than that of the array substrate 131.

A flexible printed circuit (FPC) 136 is provided on one end side of the array substrate 131. A plurality of Outer Lead Bonding (OLB) pads 1381 is provided near the flexible printed circuit 136 on the array substrate 131, and each of the OLB pads 1381 is electrically connected to the flexible printed circuit 136. Some of the OLB pads 1381 are connected to the respective partial electrodes of the second electrode portion 1332 via a signal line 137. A transfer pad 1382 is provided on the counter substrate 132. Some of the OLB pads 1381 are connected to the first electrode portion 1331 via the transfer pad 1382 and the signal line 137. Accordingly, it is configured that voltages applied to the first electrode portion 1331 and the second electrode portion 1332 are controlled by a circuit connected via the flexible printed circuit 136.

Between the first electrode portion 1331 and each of the plurality of partial electrodes constituting the second electrode portion 1332, whether a predetermined voltage is applied or not is controlled. By controlling the voltages applied to these electrode portions, it is possible to switch, for each partial electrode, a corresponding region between a light-shielding region and a light-transmitting region, thereby forming an aperture having a designated pattern.

The alignment film 135 is disposed on each of the first electrode portion 1331 disposed on the array substrate 131 and the second electrode portion 1332 disposed on the counter 135 are composed of, for substrate 132. The alignment films example, polyimide or the like.

The liquid crystal 139 is filled in a space surrounded by the alignment film 135 on the array substrate 131, the alignment film 135 on the counter substrate 132, and the sealing material 134.

### <Problems Found by Inventors>

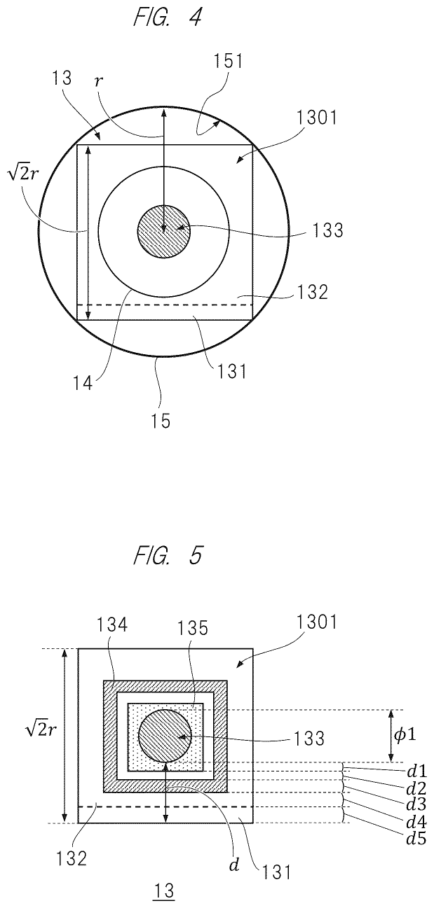

FIG. 4 is a diagram illustrating a configuration example of an interior of the cylindrical member in the reference imaging system module. FIG. 5 is a diagram illustrating a configuration example of a main part of the liquid crystal panel in the reference imaging system module.

As illustrated in FIG. 4, a panel surface 1301 of the liquid crystal panel 13 is disposed so as to be inscribed in an inner cylindrical surface 151 of the cylindrical member 15. As illustrated in FIG. 5, when the liquid crystal panel 13 is viewed in the optical axis direction, it can be seen that an edge of the counter substrate 132 is located inside an edge of the array substrate 131, the sealing material 134 is located inside the edge of the counter substrate 132, the alignment film 135 is located inside the sealing material 134, and further, the electrode portion 133 is located inside the alignment film 135.

Here, it is assumed that the liquid crystal panel 13 is disposed so as to be inscribed in the inner cylindrical surface of the cylindrical member 15. It is also assumed that the array substrate 131 is square and that the second electrode portion 1332 has a circular shape. In this case, when r represents an inner radius of the cylindrical member 15, and d represents the shortest distance from an edge of the array substrate 131 to the electrode portion 133, a diameter φ1 of the electrode portion 133 can be expressed by the following Equation (1).

$$\begin{matrix}[ Expression 1 ] & \\ \begin{matrix}ϕ 1 = \sqrt{2} \cdot r - 2 d \\ \approx 1.41 \cdot r - 2 d\end{matrix} & ( 1 )\end{matrix}$$

It should be noted that the shortest distance d from the edge of the array substrate 131 to the electrode portion 133 is, as illustrated in FIG. 5, represented as a total sum of distances d1 to d5. The distance d1 is a distance from the edge of the electrode portion 133 to an edge of the alignment film 135. The distance d2 is a distance from the edge of the alignment film 135 to an inner edge of the sealing material 134. The distance d3 is a width of the sealing material 134, that is, a distance from the inner edge to an outer edge of the sealing material 134. The distance d4 is a distance from the outer edge of the sealing material 134 to an edge of the counter substrate 132. The distance d5 is a distance from the edge of the counter substrate 132 to the edge of the array substrate 131. Each of these distances d1 to d5 has a minimum value determined by manufacturing constraints of the liquid crystal panel. Therefore, the distance d, which is the sum of the distances d1 to d5, can be regarded as being substantially fixed on the assumption that the distance d takes a minimum value, provided that the manufacturing environment of the liquid crystal panel is the same.

As described above, there is a limitation in reducing the distance d from the edge of the array substrate 131 to the electrode portion 133. The inner radius r of the cylindrical member 15 is determined by the size of the cylindrical member 15. Accordingly, even when it is desired to increase a diameter φ1 of the electrode portion 133 relative to the cylindrical member 15, the diameter φ1 cannot be increased because a plate surface of the array substrate 131 has a rectangular shape and the panel surface 1301 of the liquid crystal panel 13 has a rectangular shape. In other words, in the imaging system module 1, the size of the electrode portion 133 of the liquid crystal panel 13 cannot be made sufficiently large relative to the cross-sectional area of the cylindrical member 15, so that an aperture formed by the liquid crystal panel 13 becomes small, resulting in a problem that practicality is impaired.

In view of the above circumstances, the present inventors have conducted extensive research and devised the present disclosure. Embodiments of the present disclosure will be described below. It should be noted that the embodiments described below are merely examples for carrying out the present disclosure and are not intended to limit the technical scope of the present disclosure. In the following embodiments, components having the same functions are denoted by the same reference numerals, and repetitive descriptions thereof will be omitted unless particularly necessary

### First Embodiment

### Overview of Imaging System Module According to First Embodiment

An imaging system module according to a first embodiment of the present application will be described. In the imaging system module according to the first embodiment, a shape of a panel surface of a liquid crystal panel is an N-polygonal shape, where N is a natural number greater than four. More specifically, the shape of the panel surface of the liquid crystal panel is an octagonal shape, and still more specifically, the shape of the panel surface of the liquid crystal panel is a regular octagonal shape.

### Configuration Example of Imaging System Module According to First Embodiment

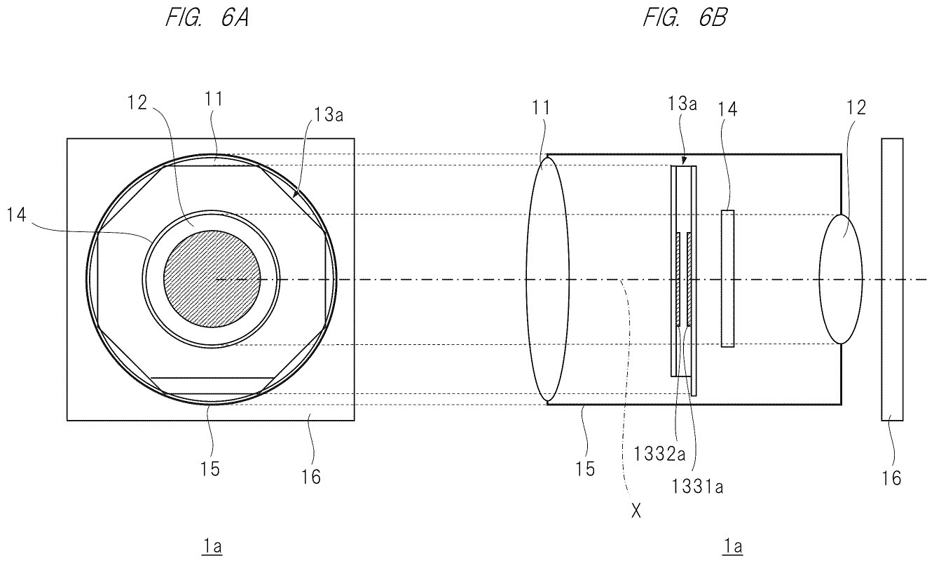

FIGS. 6A and 6B are diagrams illustrating a configuration of an imaging system module 1a according to the first embodiment. FIG. 6A is a front diagram illustrating a configuration of the imaging system module 1a, illustrating a configuration example when the module is viewed in an optical axis direction. FIG. 6B is a side diagram illustrating a configuration of the imaging system module 1a, illustrating a configuration example when the module is viewed in a direction orthogonal to the optical axis. As understood from FIGS. 6A and 6B, a basic configuration of the imaging system module 1a according to the first embodiment is similar to that of the reference imaging system module 1, except that a configuration of a liquid crystal panel 13a is different from that of the liquid crystal panel 13.

As illustrated in FIGS. 6A and 6B, the imaging system module 1a includes a first lens 11, a second lens 12, the liquid crystal panel 13a, an aperture assembly 14, a cylindrical member 15, and an imaging element 16. The first lens 11, the second lens 12, the liquid crystal panel 13a, the aperture assembly 14, the cylindrical member 15, and the imaging element 16 have functions and serve similarly to those of the corresponding components in the reference imaging system module 1. The liquid crystal panel 13a includes a first electrode portion 1331a disposed on an array substrate side and a second electrode portion 1332a disposed on a counter substrate side. It should be noted that the aperture assembly 14 may be omitted as needed. And the imaging element 16 may be separated from the imaging system module 1 as needed.

In the imaging system module 1a according to the first embodiment, compared with the reference imaging system module 1, particularly, a shape of a panel surface 1301a of the liquid crystal panel 13a, that is, shapes of an array substrate 131a and a counter substrate 132a, and a size of an electrode portion 133a are different.

### Configuration Example of Liquid Crystal Panel According to First Embodiment

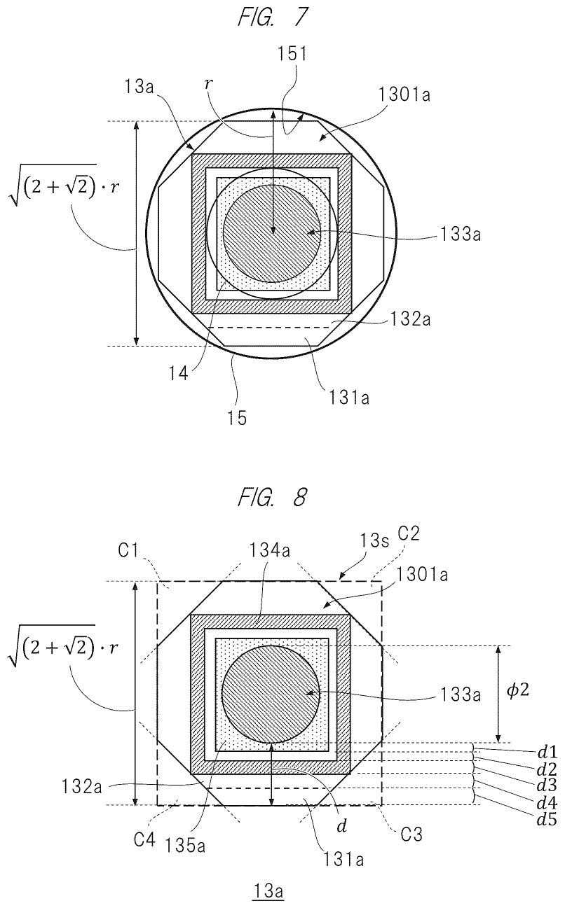

FIG. 7 is a diagram illustrating a configuration example of an interior of a cylindrical member in the imaging system module according to the first embodiment. Also, FIG. 8 is a diagram illustrating a configuration example of a liquid crystal panel in the imaging system module according to the first embodiment.

As illustrated in FIG. 7, the panel surface 1301a of the liquid crystal panel 13a has a regular octagonal shape and is disposed so as to be inscribed in an inner cylindrical surface 151 of the cylindrical member 15. In other words, the panel surface 1301a has a size such that it is inscribed in the inner cylindrical surface 151. An inner radius r of the cylindrical member 15 is the same as that in the case of the reference imaging system module 1. In this case, a distance between facing sides of the panel surface of the liquid crystal panel 13a is √(2+√2)·r≈1.85·r, which is larger than the corresponding distance √2·r≈1.41·r in the case of the reference imaging system module 1. On the other hand, a distance d from an edge of the electrode portion 133a to an edge of the array substrate 131a, that is, a minimum value of the total sum of distances d1 to d5 illustrated in FIG. 8, is fixed due to manufacturing or design constraints, and is the same as that in the case of the reference imaging system module 1.

Accordingly, positions of respective edges of the electrode portion 133a, the alignment film 135a, the sealing material 134a, the counter substrate 132a, and the array substrate 131a are shifted outward from the center of the panel surface as compared with those in the case of the reference imaging system module 1, and it can be seen that a diameter φ2 of the electrode portion 133a is larger than φ1. In other words, the size of the electrode portion 133a relative to the cross-sectional area of the cylindrical member 15 can be made larger than that in the case of the reference imaging system module 1.

The reason why such an effect can be obtained is that a distance from the inner cylindrical surface 151 of the cylindrical member 15 to the farthest edge among the edges of the panel surface of the liquid crystal panel 13a becomes shorter, thereby allowing outer edges of the sealing material 134a and the alignment film 135a to be positioned farther outward. Therefore, as long as the panel surface 1301a of the liquid crystal panel 13a has an N-polygonal shape in which N is a natural number greater than four, the outer edges of the sealing material 134a and the alignment film 135a can be positioned farther outward than in the case of the reference imaging system module 1, making it possible to increase the size of the electrode portion 133a.

In addition, when the panel surface 1301a of the liquid crystal panel 13a has a size inscribed in the inner cylindrical surface 151 of the cylindrical member 15, the electrode portion 133a can be made the largest. However, in actual implementation, it is also conceivable that the liquid crystal panel 13a may be fixed to the inner cylindrical surface 151 of the cylindrical member 15 through a stay or the like. In such a case, the panel surface 1301a may have a size slightly smaller than the size inscribed in the inner cylindrical surface 151 of the cylindrical member 15, but even in that case, the electrode portion 133a can be made sufficiently large as compared with the case where the panel surface has a rectangular shape.

From the above viewpoint, it is preferable that the panel surface of the liquid crystal panel 13a be a regular N-polygonal shape among the N-polygonal shapes. It is also preferable that the larger the N, the better. That is, ultimately, the most advantageous case is when N=∞ (infinity), and from the viewpoint of enlarging the electrode portion 133a, it is most preferable that the panel surface of the liquid crystal panel 13a have a circular shape and have substantially the same cross-sectional area as a cross section of the cylindrical member 15. In other words, whether the panel surface has an N-polygonal shape or a circular shape, it is preferable that the panel surface have a size inscribed in the inner cylindrical surface of the cylindrical member 15.

On the other hand, when attempting to manufacture the liquid crystal panel 13a having a panel surface of an N-polygonal shape with a relatively large N, another problem arises. In practice, due to functional limitations of manufacturing equipment, it is conceivable that a liquid crystal panel having a rectangular panel surface is first manufactured, and thereafter, a linear cutting process is repeatedly performed so that the panel surface becomes an N-polygonal shape. In this case, as the number of linear cutting processes increases, the number of manufacturing steps increases, resulting in higher manufacturing costs and longer manufacturing time. In other words, it is necessary to consider a balance between the obtained effect and the cost. One example in which this balance is appropriate is a case where the panel surface is formed into an octagonal shape. As illustrated in FIG. 8, first, a liquid crystal panel 13s having a rectangular panel surface, which can be easily manufactured by general manufacturing equipment, is manufactured. Next, corner portions C1 to C2 of the liquid crystal panel 13s are cut with a cutter. By such a simple process with a small number of steps, a liquid crystal panel 13a having an octagonal panel surface can be manufactured. In addition, when the panel surface is octagonal, gaps are formed between the inner cylindrical surface of the cylindrical member 15 and the panel surface, and the flexible printed circuit 136, connection cables and the like can be passed through the gaps, facilitating design and implementation.

Among the octagonal shapes, it is preferable that the panel surface of the liquid crystal panel 13a be a regular octagonal shape. First, it is considered easy to manufacture the liquid crystal panel 13s having a square panel surface. Next, by linearly cutting corner portions C1 to C2 of the liquid crystal panel 13s having the square panel surface at predetermined angles, the liquid crystal panel 13a having a panel surface of a regular octagonal shape can be manufactured. Furthermore, when the panel surface is a regular octagonal shape, the electrode portion 133a can be made the largest among the octagonal shapes.

It is preferable that, when the liquid crystal panel is to be cut, positions of the sealing material 134a and the alignment film 135a be adjusted in advance on the assumption that the liquid crystal panel 13s will be cut.

Here, in a case where the liquid crystal panel 13a is disposed so as to be inscribed in the inner cylindrical surface of the cylindrical member 15, a diameter φ2 of the electrode portion 133a, particularly a diameter of the second electrode portion 1332a (FIG. 6), can be expressed by the following Equation (2).

$$\begin{matrix}[ Expression 2 ] & \\ \begin{matrix}ϕ 2 = \sqrt{( 2 + \sqrt{2} )} \cdot r - 2 d \\ \approx 1.85 \cdot r - 2 d\end{matrix} & ( 2 )\end{matrix}$$

### <Comparison of Imaging System Modules>

When comparing a diameter φ1 of the electrode portion 133 in the reference imaging system module 1 with a diameter @2 of the electrode portion 133a in the imaging system module 1a according to the first embodiment, it can be seen from the difference in the coefficient of r that 42 is larger. In other words, an area of the electrode portion 133a can be made larger, and an aperture formed thereby can be made larger.

Here, a comparison of the diameters φ of the electrode portions will be described using specific numerical values for intuitive understanding.

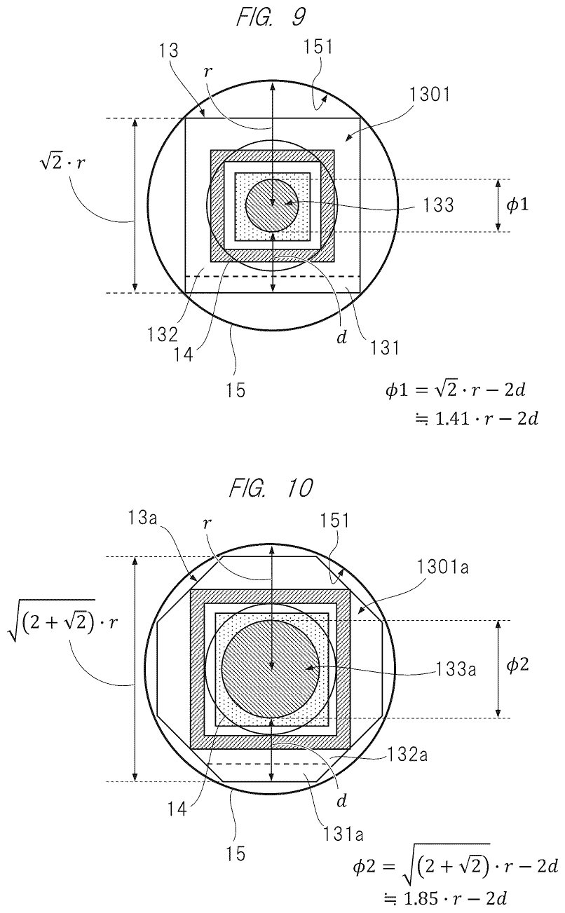

FIG. 9 is a front diagram illustrating a configuration of the liquid crystal panel 13 in the reference imaging system module 1. FIG. 10 is a front diagram illustrating a configuration of the liquid crystal panel 13a in the imaging system module 1a according to the first embodiment.

As a specific example, the following is assumed. As illustrated in FIG. 10, the liquid crystal panel 13a according to the first embodiment has a panel surface 1301a having a regular octagonal shape. The size of the panel surface 1301a is such that it is inscribed in the inner surface 151 of the cylindrical member 15.

Further, as illustrated in FIG. 8, the shortest distance d from an edge of each of the array substrate 131 and the array substrate 131a to each of the electrode portion 133 and the electrode portion 133a (in particular, the second electrode portion 1332a) is composed of distances d1 to d5, which are as follows. A shortest distance d1 from an edge of each of the electrode portion 133 and the electrode portion 133a to an edge of each of the alignment film 135 and the alignment film 135a is 1 mm. A shortest distance d2 from the edge of each of the alignment film 135 and the alignment film 135a to an edge of each of the sealing material 134 and the sealing material 134a is 1 mm. A distance d3 corresponding to the width of each of the sealing material 134 and the sealing material 134a is 3 mm. A shortest distance d4 from an edge of each of the sealing material 134 and the sealing material 134a to an edge of each of the counter substrate 132 and the counter substrate 132a is 1 mm. A shortest distance d5 from an edge of each of the counter substrate 132 and the counter substrate 132a to an edge of each of the array substrate 131 and the array substrate 131a is 3 mm. In addition, the inner radius r of the cylindrical member 15 is 15 mm.

In this case, since the distance d from the edge of each of the array substrate 131 and the array substrate 131a to each of the electrode portion 133 and the electrode portion 133a is the sum of the distances d1 to d5, the distance d becomes 9 mm. In the case of the reference imaging system module 1, that is, when the panel surface of the liquid crystal panel 13 has a square shape, substituting d=9 and r=15 into Equation (1) gives Equation (3) below, and the diameter φ1 of the electrode portion 133, particularly the second electrode portion 1332, is found to be 3.15 mm.

$$\begin{matrix}[ Expression 3 ] & \\ \begin{matrix}ϕ 1 = \sqrt{2} \cdot r - 2 d \\ \approx 1.41 \times 15 - 2 \times 9 \\ = 21.15 - 18 \\ = 3.15\end{matrix} & ( 3 )\end{matrix}$$

On the other hand, in the case of the imaging system module 1a according to the first embodiment, that is, when the panel surface of the liquid crystal panel 13a has a regular octagonal shape, substituting d=9 and r=15 into Equation (2) gives Equation (4) below, and the diameter 42 of the electrode portion 133a, particularly the second electrode portion 1332a, is found to be 9.75 mm.

$$\begin{matrix}[ Expression 4 ] & \\ \begin{matrix}ϕ 2 = \sqrt{( 2 - \sqrt{2} )} \cdot r - 2 d \\ \approx 1.85 \times 15 - 2 \times 9 \\ = 27.75 - 18 \\ = 9.75\end{matrix} & ( 4 )\end{matrix}$$

It should be noted that, if the panel surface 1301a of the liquid crystal panel 13a is assumed to have a circular shape, the diameter φ3 of the electrode portion 133a can be expressed by the following Equation (5).

$$\begin{matrix}[ Expression 5 ] & \\ ϕ 3 = 2 r - 2 d & ( 5 )\end{matrix}$$

By substituting d=9 and r=15 into Equation (5), the expression can be expressed as Equation (6) below, and the diameter φ3 of the electrode portion 133a, particularly the second electrode portion 1332a, is found to be 12 mm.

$$\begin{matrix}[ Expression 6 ] & \\ \begin{matrix}ϕ 3 = 2 r - 2 d \\ = 2 \times 15 - 2 \times 9 \\ = 30 - 18 \\ = 12\end{matrix} & ( 6 )\end{matrix}$$

### Main Effects of Imaging System Module According to First Embodiment

As described above, when the liquid crystal panel 13a that forms a coded aperture is applied to the imaging system module 1a according to the first embodiment, and the liquid crystal panel 13a is disposed so as to be inscribed in the inner surface of the cylindrical member 15, it is preferable that the panel shape of the liquid crystal panel 13a be an N-sided polygon, where N is a natural number greater than four. In this case, compared with the case where the panel shape of the liquid crystal panel 13a is a quadrilateral such as a square or a rectangle, the electrode portion 133a of the liquid crystal panel 13a can be made larger relative to the cross-sectional size of the cylindrical member 15. Furthermore, when the panel shape of the liquid crystal panel 13a is a regular N-sided polygon, the electrode portion 133a of the liquid crystal panel 13a can be made even larger relative to the cross-sectional size of the cylindrical member 15.

It should be noted that, when the panel surface 1301a of the liquid crystal panel 13a has an octagonal shape, the panel can be formed simply by cutting off the four corners of a rectangular liquid crystal panel 13s, so that the size of the electrode portion 133a of the liquid crystal panel 13a can be increased to a value close to the upper limit while suppressing additional manufacturing steps and manufacturing costs. Furthermore, when the panel surface 1301a of the liquid crystal panel 13a has a regular octagonal shape, the electrode portion 133a of the liquid crystal panel 13a can be made even larger relative to the cross-sectional size of the cylindrical member 15.

In addition, when the panel surface 1301a of the liquid crystal panel 13a has a circular shape, the electrode portion 133a of the liquid crystal panel 13a can be made largest relative to the cross-sectional size of the cylindrical member 15.

It should be noted that formation of the shape of the panel surface 1301a of the liquid crystal panel 13a may be performed by cutting off unnecessary portions after manufacturing a liquid crystal panel 13s having a rectangular panel surface. Alternatively, the array substrate 131a and the counter substrate 132a may be pre-formed into shapes such that the panel surface has a desired shape, and then combined.

### Second Embodiment

An imaging apparatus according to a second embodiment will be described.

FIG. 11 is a diagram illustrating a configuration example of an imaging apparatus according to the second embodiment. As illustrated in FIG. 11, an imaging apparatus 3 according to the second embodiment includes an imaging system module 1a according to the first embodiment and an arithmetic control unit 2. As described above, a shape of a panel surface 1301a of a liquid crystal panel 13a in the imaging system module 1a is an N-polygonal shape (where N is a natural number greater than four), a regular N-polygonal shape, a circular shape, or a perfect circular shape. As a specific example thereof is a regular octagonal shape.

The panel surface 1301a is inscribed in an inner cylindrical surface of the cylindrical member 15. The imaging system module 1a and the arithmetic control unit 2 are electrically connected to each other so as to be capable of communication. The arithmetic control unit 2 controls the imaging system module 1a so that coded imaging is performed, and decodes an imaged image obtained by the coded imaging to estimate a depth of a subject.

More specifically, the arithmetic control unit 2 transmits a control signal to the liquid crystal panel 13a to form a designated coded aperture. The arithmetic control unit 2 also transmits a control signal to the aperture assembly 14 and controls a size of an aperture of the aperture assembly 14 so that an exposure at the time of coded imaging becomes a set exposure. The arithmetic control unit 2 controls the imaging element 16 so that coded imaging of a subject is performed by the imaging system module 1a, or controls an accumulation time of a signal received from the imaging element 16.

The arithmetic control unit 2 receives data of an imaged image obtained by coded imaging from the imaging element 16. The arithmetic control unit 2 performs a decoding process on the received image data of the imaged image based on a point spread function corresponding to a coded aperture used in the coded imaging, generates an image of a subject with improved blur, and calculates an estimated depth value of the subject. Furthermore, the arithmetic control unit 2 generates a depth map by superimposing the calculated estimated depth value of the subject on the image of the subject, and outputs the depth map to an external device. The external device may be, for example, a driving assistance device or an automatic braking device for a vehicle.

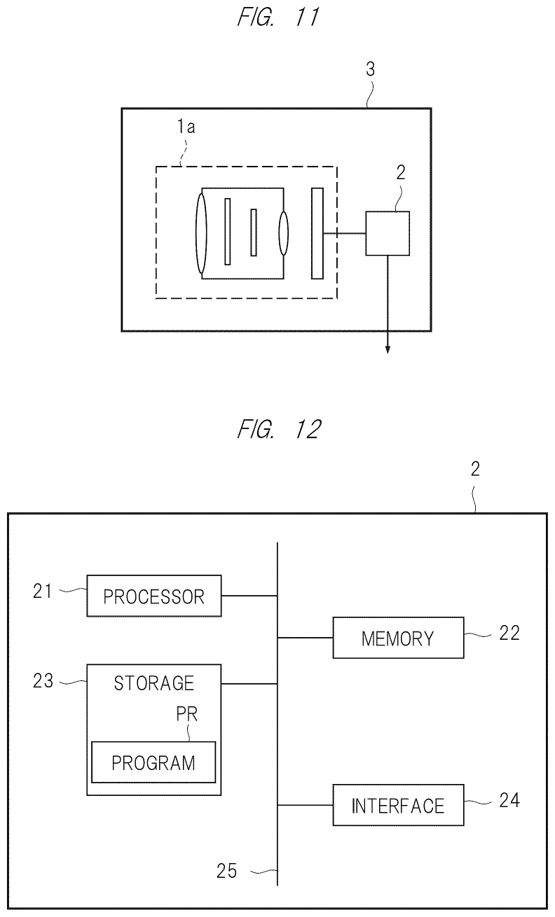

FIG. 12 is a diagram illustrating a configuration example of the arithmetic control unit according to the second embodiment. As illustrated in FIG. 12, the arithmetic control unit 2 includes, for example, a processor 21, a memory 22, a storage 23, an interface 24, and a communication bus 25. The processor 21, the memory 22, the storage 23, and the interface 24 are each connected to the communication bus 25 and are capable of communicating with one another via the communication bus 25.

The processor 21 is, for example, a Central Processing Unit (CPU), a Micro Processor Unit (MPU), or a Micro Controller Unit (MCU). The memory 22 is, for example, a semiconductor memory device such as a Random Access Memory (RAM) or a Read Only Memory (ROM). The storage 23 is, for example, a semiconductor memory device including a Solid State Drive (SSD) or a magnetic storage device including a Hard Disk Drive (HDD). A program PR is stored in the storage 23. The processor 21 implements various functions described above, for example, control processing of coded imaging, processing for calculating an estimated depth value of a subject, and processing for generating a depth map, by reading and executing the program PR. The interface 24 outputs the generated depth map and the like to the external device. It should be noted that the program PR may be stored in the ROM.

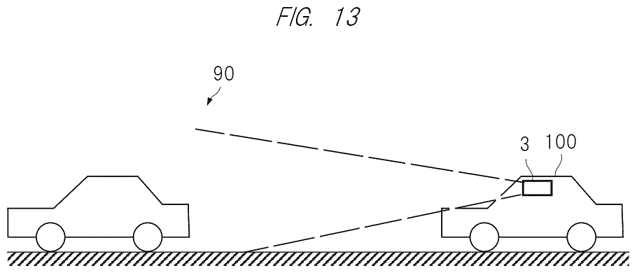

FIG. 13 is a diagram illustrating an application example of the imaging apparatus according to the second embodiment. As illustrated in FIG. 13, the imaging apparatus 3 may be installed, for example, in an automobile 100 to perform depth estimation of a subject 90 located in front, generate a depth map of the subject, and output the depth map to a driving assistance system or the like. The imaging apparatus 3 may also be installed in a vehicle other than an automobile, such as in a railway or monorail train, a motorcycle, or a bicycle. Even in such installation examples, the imaging apparatus 3 exhibits the same effects as in the above embodiment and can be utilized, for example, for driving assistance techniques.

Although various embodiments of the present disclosure have been described above, the present disclosure is not limited to the embodiments described above, and various modifications are included. The embodiments described above have been described in detail for easy understanding of the present disclosure, and the disclosure is not necessarily limited to the configurations including all of the components described. It is possible to replace part of the configuration of one embodiment with that of another embodiment, or to add the configuration of one embodiment to that of another. All of these fall within the scope of the present disclosure. Further, the numerical values and the like included in the text and figures are merely examples, and using different numerical values and the like does not compromise the effects of the present disclosure.

What is claimed is:

1. An imaging system module comprising:
a first lens;
a second lens disposed on an optical axis of the first lens;
a liquid crystal panel disposed between the first lens and the second lens; and
a cylindrical member having a cylindrical shape and supporting the first lens, the second lens, and the liquid crystal panel inside a cylinder,
wherein the liquid crystal panel is controlled externally to form an aperture having a designated pattern,
a panel surface of the liquid crystal panel has an N-polygonal shape, and
N is a natural number greater than four.

2. The imaging system module according to claim 1,
wherein the N-polygonal shape is an octagonal shape.

3. The imaging system module according to claim 2,
wherein the octagonal shape is a regular octagonal shape.

4. The imaging system module according to claim 1,
wherein the N-polygonal shape is a regular N-polygonal shape, and
the panel surface has a size inscribed in an inner cylindrical surface of the cylindrical member.

5. The imaging system module according to claim 1,
wherein the liquid crystal panel forms a coded aperture used for coded imaging.

6. The imaging system module according to claim 1,
wherein the liquid crystal panel includes:
an array substrate;
a counter substrate facing the array substrate;
a frame-shaped sealing material disposed in close contact between the array substrate and the counter substrate;
electrode portions respectively disposed on surfaces of the array substrate and the counter substrate that face each other and are located inside the sealing material; and
liquid crystal filled in a space surrounded by the array substrate, the counter substrate, and the sealing material.

7. The imaging system module according to claim 1, further comprising
an aperture assembly provided between the liquid crystal panel and the second lens, the aperture assembly being controlled externally to change a size of an aperture.

8. The imaging system module according to claim 1, further comprising
an imaging element that receives light that has passed through the first lens and the second lens and performs photoelectric conversion.

9. An imaging system module comprising:
a first lens;
a second lens disposed on an optical axis of the first lens;
a liquid crystal panel disposed between the first lens and the second lens; and
a cylindrical member having a cylindrical shape and supporting the first lens, the second lens, and the liquid crystal panel inside a cylinder,
wherein the liquid crystal panel is controlled externally to form an aperture having a designated pattern, and
a panel surface of the liquid crystal panel has a circular shape.

10. The imaging system module according to claim 9,
wherein the panel surface has a size inscribed in an inner cylindrical surface of the cylindrical member.

11. An imaging apparatus comprising:
an imaging system module; and
an arithmetic control unit,
wherein the imaging system module includes:
a first lens;
a second lens disposed on an optical axis of the first lens;
a liquid crystal panel disposed between the first lens and the second lens; and
a cylindrical member having a cylindrical shape and supporting the first lens, the second lens, and the liquid crystal panel inside a cylinder,
the liquid crystal panel is controlled by the arithmetic control unit to form an aperture having a designated pattern,
a panel surface of the liquid crystal panel has an N-polygonal shape,
N is a natural number greater than four, and
the arithmetic control unit controls the imaging system module so that coded imaging is performed, and decodes an imaged image obtained by the coded imaging to calculate an estimated depth value of a subject.

12. The imaging apparatus according to claim 11,
wherein the N-polygonal shape is an octagonal shape.

13. The imaging apparatus according to claim 12,
wherein the octagonal shape is a regular octagonal shape.

14. The imaging apparatus according to claim 11,
wherein the N-polygonal shape is a regular N-polygonal shape, and
the panel surface has a size inscribed in an inner cylindrical surface of the cylindrical member.

15. An imaging apparatus comprising:
an imaging system module; and
an arithmetic control unit,
wherein the imaging system module includes:
a first lens;
a second lens disposed on an optical axis of the first lens;
a liquid crystal panel disposed between the first lens and the second lens; and
a cylindrical member having a cylindrical shape and supporting the first lens, the second lens, and the liquid crystal panel inside a cylinder,
the liquid crystal panel is controlled by the arithmetic control unit to form an aperture having a designated pattern,
a panel surface of the liquid crystal panel has a circular shape, and
the arithmetic control unit controls the imaging system module so that coded imaging is performed, and decodes an imaged image obtained by the coded imaging to calculate an estimated depth value of a subject.
